(19) United States
(12) Patent Application Publication
(10) Pub. No.: US 2002/0140183 A1
(43) Pub. Date: Oct. 3, 2002

(54) Trapezoid-shaped fabric cover for protecting and polishing and operating piston

(76) Inventor: Eddie Santiago-Diaz, Guaynabo, PR (US)

Correspondence Address: JACOBSON HOLMAN PLLC, 400 SEVENTH STREET N.W., SUITE 600, WASHINGTON, DC, 20004, US

(21) Appl. No.: 09/820,618

(22) Filed: Mar. 30, 2001

(51) Int. Cl. F16J 15/52

(52) U.S. Cl. 277/634

(57) ABSTRACT

A protective cover particularly adapted for a piston having a piston rod and a cylinder is disclosed. The cover is a trapezoid-shaped dual layer fabric with either elastic or drawstring tie fasteners or a combination of both at the opposite parallel edges, and complementary closure fasteners, such as plastic loop and pile strips, along the angled sides. The trapezoid-shaped fabric is wrapped around the portion of the piston cylinder from which the piston rod extends and the fastener strips are engaged. The tie fasteners are tightened around the adjacent part of the piston rod and part of the cylinder to completely enclose this portions of the piston. As the rod reciprocates in and out of the cylinder, the fabric protects the adjacent piston rod and cylinder head from dirt and debris, and acts to polish the piston rod as it reciprocates in and out of the cylinder head.

### BACKGROUND OF THE INVENTION

1. Field of the Invention

The present invention relates to a protective cover for an exposed piston rod or shaft of a reciprocating piston or jack, such as a hydraulic lift jack or the like. More specifically, the present invention relates to a fabric cover for protecting the piston rod and jack seal from debris and environmental dust and for polishing the exposed piston rod as it reciprocates.

2. The Prior Art

Throughout the years, many devices have been made to stop dirt and debris from collecting on a piston rod or accumulating on a seal near the top of a cylinder as the piston rod reciprocates in and out. The dirt and debris collecting in the noted areas can cause problems in the operation of the piston. For example, dirt built up near the top of the cylinder or cylinder head will slow down the piston rod from reciprocating in and out of the cylinder. As more dirt builds up, more friction develops in this noted area. A piston seal which normally is positioned in this area gets covered with dirt and wears quickly, becomes dried out, causes leakage of the hydraulic fluid and ultimately must be replaced more often.

Additionally, as the friction builds up, which in turn causes the piston rod to work harder to reciprocate in and out of the cylinder, there is undue strain placed on the remaining components, such as the hydraulic motor. It would be desirable to remove or eliminate this dirt build-up and at the same time polish the piston rod to reduce the amount of friction.

By polishing the piston rod, it remains smooth. This facilitates a reduction of friction during the reciprocating movement. This reduction of friction permits the rod to reciprocate more smoothly and steadily without as much work from the motor. Accordingly, the efficiency of the entire jack is increased.

Over the years, there have been a number of devices which have attempted to protect exposed areas of hydraulic jacks and the like from dirt and debris. One example of an earlier device is found in U.S. Pat. No. 1,585,189 which discloses a leather or flexible collar or boot having a tapered body and an inner end opening adapted to fit snugly over the rear axle of a standard Ford automobile. While this device eliminates some of the dirt from collecting on the axle, there is no attempt to polish the axle. In fact, this device was not built for polishing.

In U.S. Pat. Nos. 2,787,801 to Butler and 3,466,693 to Grant, attempts were made to eliminate the build up of dirt and debris. In these devices, a generally flat pipe wiper is used to scrape oil, mud and other substances from the surfaces of drill pipes as the pipes are raised out of the well casing. Each of the scrapers are hard rubber devices which do not polish the pipe nor prevent dirt and substances from entering the well. Basically, the devices scrape the pipes for later use.

U.S. Pat. No. 5,048,643 to Trapasso et al discloses a generally flat flexible skirt for surrounding a piston of a hydraulic vehicle lift assembly. The skirt includes a sewn-in elasticized cord to retain the skirt around the piston and VELCRO strips to retain the adjacent edges of the skirt together. This skirt also does not polish the piston rod. Additionally, while the skirt is somewhat protective of the seal, the skirt is not readily removable, since it is bolted to the floor.

Finally, U.S. Pat. No. 5,273,490 to Stewart et al. discloses an abrasion resistant protective cover or sock for extending over a drive axle joint seal. However, none of these prior patents disclose a protective cover which polishes the piston rod while at the same time protecting the rod and seal area from dust and debris and which can be easily removed for cleaning when desired.

### SUMMARY OF THE INVENTION

In view of the problems and disadvantages of the prior art, the present invention seeks to provide a dual material protective cover which is particularly adapted for a reciprocating piston of a hydraulic jack or the like. More specifically, the protective cover of the present invention is specially shaped and configured to attach over the piston and jack seal area to cover a part of the piston rod and the piston cylinder at the area where the piston rod reciprocates in and out of the cylinder head.

In order to fit snugly over the piston rod at one end and over the top of the jack cylinder head at the other end, the protective cover of the present invention is specially shaped in a generally frustoconical shape when installed. When open and laid flat, the fabric forming the cover has a generally trapezoid shape. The cover has at least two layers, an inner layer made of a material which polishes the exposed portion of the piston rod as it reciprocates into and out of the cylinder and an outer layer to protect the inner layer, exposed rod and cylinder head from dust and debris.

The top and bottom edges of the cover, preferably both layers, are rolled and stitched over in order to receive drawstrings or the like to draw each end of the cover over the respective piston rod and cylinder head. These edges are also preferably elasticized, such as by applying an elastic strip, so as to contract around the piston rod and cylinder when installed, with or without the drawstrings.

The angled sides of the trapezoid-shaped cover overlap when the cover is installed and are provided along their length with complementary loop and pile fastener strips, such as VELCRO strips. Then, when the cover is folded around the jack area to be protected, the loop and pile fasteners are adhered together. The drawstrings and/or elastic edges at the top and bottom are drawn and secured with the top around the piston rod and the top around the cylinder head. The cover is then in position to protect the sealed area and at the same time polish the piston rod as it reciprocates. The cover can be easily removed by undoing the drawstrings and unconnecting the loop and pile fastener strips.

Accordingly, it is an object of the present invention to provide a protective cover for hydraulic jacks, pistons and the like in the area where the piston rod reciprocated in and out of the cylinder head.

It is another object of the present invention to provide a cover in accordance with the preceding object which also is made of a trapezoid-shape fabric to form a generally frustoconical shaped cover to wrap around the smaller diameter piston at one end and the larger diameter cylinder head at the other end.

It is a further object of the present invention to provide the cover with an inside fabric layer and an outside fabric layer for wrapping around the piston rod and cylinder head with the inside fabric layer made out of a polishing fabric or material in order to polish the piston rod as the piston rod reciprocates in and out of the cylinder and the outside fabric layer made out of a protective fabric or material in order to protect the inner fabric layer, the piston rod and the cylinder head from dirt and debris.

Yet another object of the present invention is to provide the angled sides of the fabric with opposed loop and pile fastener strips so that the edges can adhere to each other when the fabric is wrapped around the piston rod and cylinder head to form the generally frustoconical cover.

A still further object of the present invention is to provide the fabric cover with stitched over edges along the parallel sides in order to receive tie fasteners for tightening the cover around the piston rod and the cylinder head to completely enclose the portion of the piston to be protected.

Yet another object of the present invention is to provide a trapezoid-shaped fabric cover in accordance with the preceding objects and which will conform to conventional forms of manufacture, be of simple construction and easy to use so as to provide a device that will be economically feasible, long lasting and relatively trouble free in operation.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a perspective view of a protective cover in accordance with the present invention assembled on a piston rod and cylinder head;

FIG. 2 is a plan view of the protective cover of FIG. 1 in an open, unfolded condition looking at the inside polishing layer;

FIG. 3 is a perspective view of the protective cover of FIG. 1 in a closed condition looking at the outside fabric layer with the fastener strips fastened; and

FIG. 4 is a cut away view of the protective cover according to the present invention as assembled on the piston.

FIG. 5 is an enlarged view of the rolled over and stitched top edge of the protective cover shown in FIG. 4.

### DESCRIPTION OF THE INVENTION

Although only one preferred embodiment of the invention is explained in detail, it is to be understood that other embodiments are possible. Accordingly, it is not intended that the invention is to be limited in its scope to the details of construction and arrangement of components set forth in the following description or illustrated in the drawings. The invention is capable of other embodiments and of being practiced or carried out in various ways. Also, in describing the preferred embodiment, specific terminology will be resorted to for the sake of clarity. It is to be understood that each specific term includes all technical equivalents which operate in a similar manner to accomplish a similar purpose.

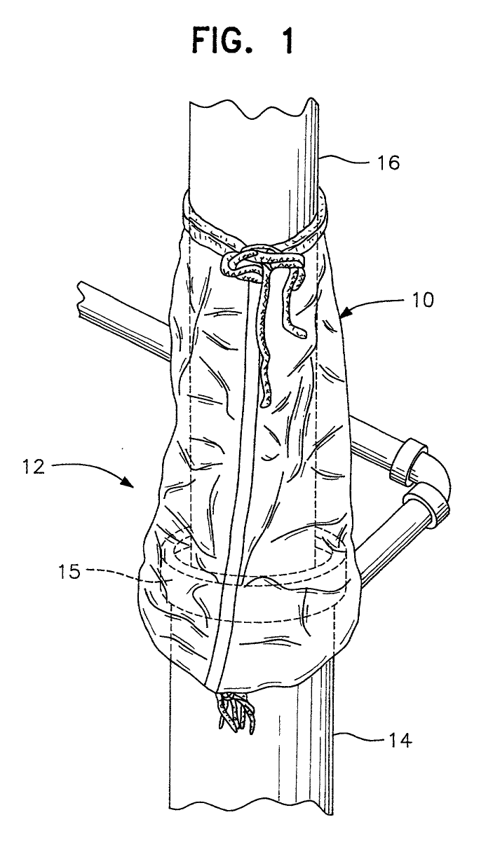

FIG. 1 illustrates the protective cover of the present invention, generally designated by reference numeral 10, covering part of a piston, generally designated by reference numeral 12. The piston 12 includes a piston cylinder 14 and a piston rod 16, and cylinder 14 includes a cylinder head 15. In operation, the piston rod 16 moves in and out of the piston cylinder 14 through the cylinder head 15. This reciprocating action is regularly repeated and necessary in the operation of the piston. As the piston rod 16 reciprocates in and out of the cylinder 14 through the cylinder head 15, a part of the piston rod 16 is constantly exposed.

The protective cover 10 is placed over the piston 12 in the area of the exposed piston rod 16 and the cylinder head 15 adjacent thereto. The protective cover 12 is thus able to capture the dust from the environment surrounding the piston 12 and keep out the dust and dirt from the cylinder 14 as the piston rod moves in and out of the cylinder head 15. The cover 10 preferably consists of at least two layers of two different types of fabric. The outside layer 30 is preferably made of a strong and soft fabric, such as a cotton blanking material (a 100% cotton fabric starting material) or the like, which will capture and retain the dust particles with its fibers. The second or inside layer 20 is made of a different fabric which keeps the piston rod 16 clean in the area adjacent the cylinder head 15. Preferably, the inside layer 20 is made of a polishing cloth or other suitable material which serves to polish the piston rod 16 as the rod reciprocates in and out of the cylinder head 15 of cylinder 14.

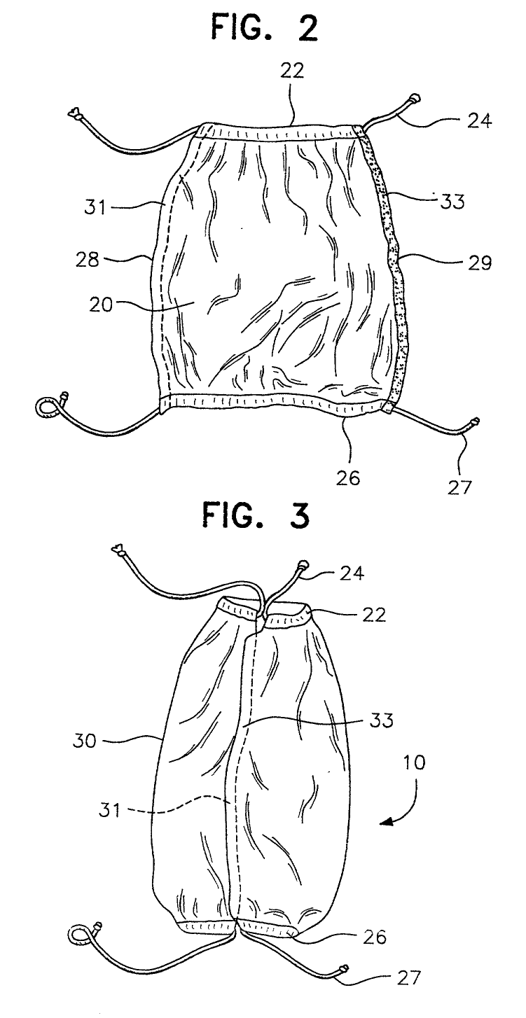

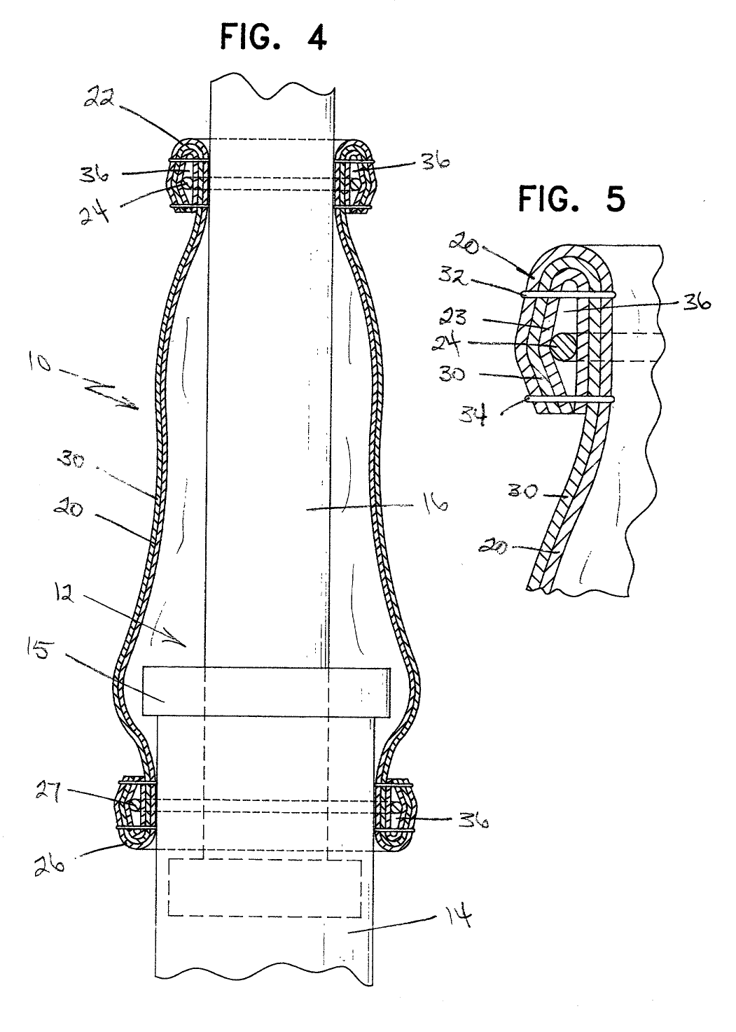

As shown in FIGS. 2, 3 and 4, the protective cover 10 has a generally trapezoidal shape when open and laid flat and a generally frustoconical shape when folded around and closed. Along the angled sides 28 and 29 of the cover 10 are complementary closure fastening strips 31 and 33. The strips are preferably made of a suitable polymeric material with a surface of tiny hooks and a complementary surface of an adhesive pile. These types of strips are more commonly known as VELCRO strips. The matching strips 31 and 33 can be pressed together or pulled apart for easy fastening and unfastening. Thus, the VELCRO strips 31 and 33 allow for ready wrapping the cover 10 over the piston 12 at the intended area to be protected.

The upper and lower edges 22 and 26 of the cover 10 preferably include elastic strips 23 (see FIG. 5) which cause the upper and lower ends of the cover to be expandable for fitting snugly around the piston rod 16 and cylinder 14 when installed. Further, the edges 22 and 26 are preferably rolled over, with the inner fabric layer 20 on the outside, and the edges double stitched as at 32 and 34 to form a channel 36 around each edge. The channels 36, top and bottom, are designed to receive drawstrings or tie strings 24 and 27. The drawstrings 24 and 27 are then tied to firmly hold the edges 22 and 26 in place on the piston rod 16 and cylinder 14, respectively.

By rolling of the inner fabric layer 20 over the outer fabric layer 30 in order to form channels 36, the polishing layer 20 remains the exposed layer along edges 22 and 26. This ensures that the polishing layer 20 along edge 22 remains firmly in contact with piston rod 16 during its reciprocation, thus continuously accomplishing the polishing/cleaning function.

As shown in FIG. 3, the cover 10 is closed by bring together the loop and pile fasteners 31 and 33 to mate along the adjacent angled sides 28 and 29. The loop and pile strips along the sides of the fabric are connected and securely closed. The outside layer 30 preferably has the properties of a filter to capture and retain dust particles and stop dust and debris from entering the protected area. Both fabric layers 20 and 30 preferably have the ability to allow air to pass through, in other words, the materials can breathe. Thus, air can easily enter and escape from the protected area.

While not preferred, it may be possible to form the protective cover to the present invention in a single fabric layer, if the proper properties can be achieved by the opposite surfaces. In other words, a one-piece fabric could be formed in accordance with the present invention in which the desired polishing characteristics are imparted to the inside surface and the desired dust capturing properties are imparted to the outer surface.

Further, it is contemplated for the present invention that the protective cover 10 be cleanable after some period of use and then reinstalled for continued use. Alternatively, the cover 10 could be made disposable for one time use over a desired time frame. In addition. other suitable fastening means could be utilized along side edges 28 and 29 instead of loop and pile strips 31 and 33, such as buttons, snaps, zippers and the like.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A protective cover particularly adapted for a piston between a piston rod and a cylinder wherein a part of the piston rod reciprocates in and out of the cylinder, said protective cover comprising:
a trapezoid-shaped fabric with opposite parallel edges and angled sides, said fabric having an inside surface and an outside surface for wrapping around the piston rod and cylinder;
protection material covering said outside surface of said fabric for protecting said piston rod and cylinder from dirt and debris;
polishing material covering said inside surface of said fabric for polishing said piston rod as it reciprocates in and out of the cylinder;
fastening means for attaching said angled sides of said fabric to each other with said inside surface of said fabric positioned around said piston and cylinder; and
adjustable means for securing said parallel sides of said fabric to said piston rod and cylinder.

2. The protective cover as recited in claim 1, wherein said means for attaching includes complementary closure fastening strips positioned along the angled sides.

3. The protective cover as recited in claim 2, wherein said complementary closure fastening strips include VELCRO strips.

4. The protective cover as recited in claim 1, wherein said means for securing said parallel sides of said fabric are tie fasteners for tightening around and completely enclosing the piston rod and piston cylinder.

5. The protective cover as recited in claim 1, wherein said means for securing said parallel sides of said fabric are elastic for tightening around and completely enclosing the piston rod and piston cylinder.

6. A protective cover for a piston rod and cylinder which comprises an inner layer and an outer layer, a top edge sized to snugly fit around said piston rod and a lower edge sized to snugly fit around said cylinder when installed, and side edges having complementary fastening means for assembling said cover around said piston rod and cylinder, said inner layer made of a polishing material to polish said piston rod as it reciprocates in and out of said cylinder head.

7. The protective cover as recited in claim 6, wherein said outer layer is made of a protective cloth to capture dust from surrounding air and protect said piston rod and cylinder from dust and debris.

8. The protective cover as recited in claim 6, wherein said upper edge and said lower edge include elastic and drawstrings to firmly fit said edges on said piston rod and said cylinder.

9. The protective cover as recited in claim 6, wherein said cover is capable of cleaning and reuse.
